(19) United States
(12) Patent Application Publication
(10) Pub. No.: US 2007/0182334 A1
(43) Pub. Date: Aug. 9, 2007

(54) High-pressure discharge lamp

(75) Inventor: Arnd Ritz, Heinsberg (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/598,608

(22) PCT Filed: Mar. 1, 2005
(86) PCT No.: PCT/IB05/50744

§ 371 Date: Sep. 6, 2006

(30) Foreign Application Priority Data
Mar. 11, 2004 (EP) 04100995.2

(51) Int. Cl. H01J 61/35

(52) U.S. Cl. 313/635

(57) ABSTRACT

The invention relates to a high-pressure discharge lamp, at least comprising a burner (2) which has a burner wall (25) and a discharge chamber (21) enclosed by said burner wall (25), wherein a region with a lowest temperature and a region with a highest temperature establish themselves at the inner and the outer contour of the burner wall (25), respectively, during operation of the lamp and in dependence on the mounting position of the lamp, and a multilayer interference filter (3) which is provided on a portion of the outer contour of the burner wall (25), which interference filter (3) reflects towards the discharge chamber (21) mainly light in that wavelength range of the IR light that has a causal relationship to the maximum emissive power of the material of the burner wall (25).

The invention relates to a high-pressure discharge lamp with at least a burner which comprises a burner wall and a discharge chamber enclosed by said burner wall, wherein a region with a lowest temperature and a region with a highest temperature establish themselves at the inner and at the outer contour of the burner wall, respectively, during operation of the lamp and in dependence on the insertion position of the lamp, and with a multilayer interference filter which is arranged on a portion of the outer contour of the burner wall, such that the interference filter reflects IR light towards the discharge chamber.

High-pressure gas discharge lamps (HID or High Intensity Discharge lamps) and in particular UHP (Ultra High Performance) lamps are used by preference inter alia for projection purposes because of their optical properties. The term “UHP” lamp (Philips) also denotes UHP-type lamps from other manufacturers within the scope of the invention.

A light source which is as close to a point shape as possible is required for these applications, i.e. the discharge arc establishing itself between the electrode tips must not exceed a certain length. Furthermore, a highest possible luminous intensity is often required in combination with as natural as possible a spectral composition of the visible light.

In such applications, where a high luminous efficacy of the light source as regards visible light is relevant, not only radiation in the desired wavelength range, but also radiation not useful for or possibly even detrimental to the relevant application is emitted. This undesirable radiation at least results in a loss of the energy expended in relation to the envisaged result. For example, no more than approximately 25 W of every 100 W of electrical energy supplied to the lamp is converted into visible radiation in the case of UHP lamps.

If high-pressure gas discharge lamps, in particular UHP lamps, are used, two essential requirements are to be fulfilled at the same time.

On the one hand, the highest temperature at the surface of the discharge chamber or inner contour of the burner wall must not become so high that a devitrification occurs of the lamp bulb, which is usually made of quartz glass. This may be problematic because the strong convection inside the discharge chamber of the lamp heats the region above the discharge arc particularly strongly.

On the other hand, the coldest spot at the surface of the discharge chamber or inner contour of the burner wall must still have such a high temperature that the mercury is not deposited there, if at all possible, but remains in the vapor state to a sufficient degree.

These two mutually conflicting requirements have the result that the maximum admissible difference between the highest and the lowest temperature is comparatively small.

Commercially available UHP lamps remain within this admissible temperature range nowadays when operated at their rated power. There is a demand, however, for a widening of the possible range of operation, for example in that the lamp is dimmed or in that a lamp type is upgraded for lamps of higher lumen output.

In the case of dimming, the temperature of said coldest spot must not drop too much. A local increase in the temperature of the burner wall is accordingly necessary. The temperature of the hottest spot must not rise too much in the case of a power rise.

There are furthermore situations in which regions are formed inside the lamp during operation which do indeed have a temperature lying between the highest and the lowest temperature, but for which the assumed temperature is not an optimum for the envisaged function. An example of this is formed by the electrodes, where the temperatures of the respective portions arranged inside the discharge chamber must not drop below a certain value if a good lamp life is to be achieved. The electrode is cooled by the burner wall of the discharge chamber where it enters this wall; the colder this wall is there, the more cooling. It could accordingly happen that this cooling brings the electrode into an unfavorable temperature range. It would accordingly be desirable in such a case to heat the wall in the location where the electrode enters the wall, although its temperature does lie between that of the coldest and that of the hottest spot.

The burner wall in the sense of the present invention is only that region of the lamp bulb which functionally encloses the discharge chamber.

U.S. Pat. No. 5,221,876 discloses a fundamental solution principle for increasing the efficacy through reflection of undesirable IR radiation back into the region of the lamp bulb so as to heat the latter additionally thereby. A multilayer interference filter serves as a reflector. The IR light (infrared light) of the emitted spectrum, which would otherwise not be utilized for lighting purposes, is reflected back to the discharge arc and reabsorbed. In the saturated lamps under advisement, which are designed as lamps for motor vehicle headlights, the entire lamp is heated indiscriminately. It is mainly this heating that leads to an intensified evaporation of metal halides inside the lamp bulb at the relevant operational temperatures of the lamp, in particular owing to heat conduction and convection. Applying the solution described above to high-pressure gas discharge lamps, in particular UHP lamps, is not possible because the temperature of the hottest spot would also be increased. It is furthermore typical of all UHP lamps that they have only low radiant intensities in the IR range in comparison with other lamp types.

A coating is known from U.S. Pat. No. 5,952,768 which reduces the heat transport from a high-pressure gas discharge lamp, in particular so as to achieve a temperature rise in the coldest region of the burner wall and at the same time significantly increase the luminous efficacy of the lamp. This coating is a multilayer interference filter which transmits visible light and absorbs (reflects) UV light in all cases. In addition, IR light originating from the light source can be reflected back to the light source by the filter. To achieve a significant increase in the luminous efficacy of the lamp, it is necessary to coat comparatively large regions of the outer surface of the colder burner wall. The coating is arranged in the coldest region of the burner wall.

It is accordingly an object of the invention to provide a high-pressure gas discharge lamp of the kind mentioned in the opening paragraph and a lighting unit with such a lamp whose lamp bulb or burner wall has an interference filter that can be effectively manufactured in industrial mass production, while the operational range of the lamp is widened without the interference filter substantially detracting from the luminous efficacy of the lamp, while the operational reliability of the lamp remains safeguarded.

The object of the invention is achieved by the characterizing features of claim 1.

The lamp according to the invention comprises at least a burner which has a burner wall and a discharge chamber enclosed by said burner wall, wherein a region with a lowest temperature and a region with a highest temperature establish themselves at the inner and the outer contour of the burner wall, respectively, during operation of the lamp and in dependence on the insertion position of the lamp, and a multilayer interference filter which is provided on a portion of the outer contour of the burner wall, which interference filter reflects towards the discharge chamber mainly light in that wavelength range of the IR light that has a causal relationship to the maximum emissive power of the material of the burner wall.

It is essential for the invention that the selected filter reflects mainly light of a wavelength that is effectively absorbed by the burner wall at the operating temperature of the lamp towards the discharge chamber. According to the invention, this absorption takes place effectively in the wavelength range where sufficient radiant power is present and the wall material is accordingly not transparent. The filter is thus selected with such a wavelength range, according to the invention, at which the wall material itself radiates most effectively. The invention here utilizes the empirical result that substances or media exposed to radiation with electromagnetic waves absorb in particular those frequencies which they themselves are capable of radiating. The filter accordingly mainly reflects radiation in the wavelength range above the transmission region of the bulb material or the material of the burner wall.

For a UHP lamp with a usual quartz bulb and an operating temperature of approximately 1000° C., for example, this is the wavelength range of infrared light. The filter thus leads to an effective reduction in the emissivity of the local surface of the burner wall as opposed to an uncoated quartz surface, with the result that the lamp can emit less heat radiation and the temperature is purposely increased in this region.

It is for this reason that the interference filter provides not a reflection of all wavelength ranges of the light not required for the relevant application, but only one wavelength range or a few wavelength ranges in a selective manner. The selection of the respective wavelength range of this light that is to be reflected by the interference filter takes place in particular on the basis of energetic considerations, i.e. the relevant wavelength range must in particular have a sufficient power level that can be absorbed in the wall material after reflection against the interference filter.

A further criterion for the interference filter is its necessary temperature stability and the fact that it should be suitable for industrial mass manufacture. Interference filters are preferred here for acting as reflectors because of the sharp cut-offs between the spectral ranges to be transmitted and to be reflected. Filter characteristics can be achieved over wide regions and with the necessary high accuracies by means of a suitable design of the layer sequences.

The reabsorption of radiation reflected in the filter provides an additional heat supply to the burner wall, i.e. in addition to the absorption in the filter. In how far this reabsorption and conversion into desired spectral regions can be realized depends in particular on the respective type of high-pressure gas discharge lamp.

A coating, for example a multilayer interference filter, in addition often leads to a decrease in the heat radiation from the lamp surface as compared with an uncoated quartz surface, so that the lamp can give off less heat and the operating temperature is raised accordingly.

The interference filter is to be suitably selected, dimensioned, and applied so as to achieve an optimum realization of the desired temperature field in the use of such a multilayer interference filter.

The dependent claims relate to advantageous further embodiments of the invention.

It is preferred that a layer with a higher refractive index and a layer with a lower refractive index occur in alternation in the layer structure of the multilayer interference filter.

Such interference filters are usually of a multilayer construction. In a multilayer construction of the interference filter, layers of higher and layers of lower refractive index alternate. The refractive index of the respective layer is determined in particular by the selected material of the layer, such that at least two dielectric materials differing in this respect are to be found in the layer structure.

It is furthermore preferred that the interference filter is arranged in that location or at least in that location where the region of lowest temperature establishes itself at the outer contour of the burner wall. The absolute coldest spot of the outer lamp surface often lies at the ends of the cylindrical lamp extremities; often, however, not on the outer contour of the burner wall.

If the filter is arranged in this manner, a temperature rise in the coldest region of the burner wall can be achieved most effectively. This arrangement is capable of influencing not only the temperature rise in the selected location, where the interference filter is provided, but also the temperature balance in the burner wall in a desired manner. It is made possible, for example, that the location of the coldest region can be shifted, and the resulting (new) coldest spot has a different temperature, i.e. higher than that of the previous coldest spot.

It is alternatively preferred that the interference filter is arranged especially not in that location or at least not in that location where the region of lowest temperature establishes itself at the outer contour of the burner wall, but in a location where the temperature prevailing without the interference filter is to be raised.

This arrangement opens further possibilities for design. It is possible, for example, to achieve a widening of operational ranges thereby.

It is furthermore preferred that the material of the burner wall of the UHP lamp is made in particular of quartz, and accordingly the interference filter is capable of reflecting mainly IR light from the wavelength range above approximately 2 μm.

The object of the invention is furthermore achieved by means of a lighting unit as claimed in claim 9.

Further details, features, and advantages of the invention will become apparent from the ensuing description of a preferred embodiment, which is given with reference to the drawing in which:

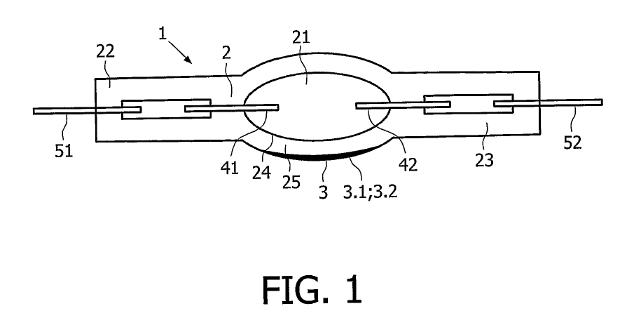

FIG. 1 is a diagrammatic cross-sectional view of a lamp bulb of a high-pressure gas discharge lamp (UHP lamp) with a multilayer interference filter.

FIG. 1 diagrammatically and in cross-section shows a lamp bulb 1 with a discharge chamber 21 of a high-pressure gas discharge lamp (UHP lamp) according to the invention. The burner 2, which is made in one integral piece, which hermetically encloses a discharge chamber 21 filled with a gas usual for the purpose, and whose material is usually hard glass or quartz glass, comprises two cylindrical, mutually opposed regions 22, 23 between which a substantially spherical region 24 with a diameter of approximately 9 mm is present. The outer contour of the burner wall 25 has an approximately spherical shape in the region of the discharge chamber 21. The discharge chamber 21 provided with an electrode arrangement is centrally arranged in the region 24. The electrode arrangement comprises substantially a first electrode 41 and a second electrode 42, between whose mutually opposed tips a luminous arc discharge is excited in the discharge chamber 21, such that the luminous arc serves as a light source in the high-pressure gas discharge lamp.

The ends of the electrodes 41, 42, which are arranged on the axis of symmetry of the UHP lamp, are connected to electric terminals 51, 52 of the lamp, via which the supply voltage necessary for operating the lamp is supplied by means of a supply unit (not shown in FIG. 1) designed for connection to a public mains voltage.

An interference filter 3 is arranged on a portion of the outer surface of the burner wall 25. The interference filter 3 is centrally arranged on the outer surface of the region 24, i.e. on the burner wall 25, along the longitudinal axis of the burner 2 and has a diameter of approximately 4 mm.

The two individual layers 3.1 and 3.2 of the interference filter 3 are characterized in particular by different refractive indices, such that a layer of lower index follows a layer of higher index each time. SiO₂ serves as the material of the layer 3.2 of lower refractive index; the material of higher refractive index of layer 3.1 is ZrO₂.

The interference filter 3 reflects mainly IR light in the wavelength range from 2 μm to 5 μm. The interference filter 3 has a transmission of approximately 90% in the visible wavelength range. The temperature difference, i.e. the difference between temperatures with and without interference filter 3, is approximately 40 K. The interference filter 3 was applied to the coldest region of the burner wall 25 with the lamp in a horizontal mounting position.

The normal operational position of UHP lamps is a horizontal position. A temperature distribution arises in this case in which the hottest spot at the outer surface of the discharge chamber 21 is uppermost and the coldest spot is at the bottom, unless measures are taken such as, for example, forced cooling from the upper side.

The layered application of the interference filter 3 takes place in a manufacturing process by means of a sputtering method that is known per se.

No appreciable impairments in excess of normal ageing of comparable lamps could be observed for a UHP lamp with the lamp bulb 1 as described above and operated at a rated power of 120 W, also after several thousands of hours of operation in the region of the upper loading limit.

A particularly advantageous embodiment of the invention relates to a high-pressure gas discharge lamp serving for projection purposes.

1. A high-pressure discharge lamp, at least
with a burner (2) which has a burner wall (25) and a discharge chamber (21) enclosed by said burner wall (25), wherein a region with a lowest temperature and a region with a highest temperature establish themselves at the inner and the outer contour of the burner wall (25), respectively, during operation of the lamp and in dependence on the mounting position of the lamp,
and with a multilayer interference filter (3) which is provided on a portion of the outer contour of the burner wall (25), which interference filter (3) reflects towards the discharge chamber (21) mainly light in that wavelength range of the IR light that has a causal relationship to the maximum emissive power of the material of the burner wall (25).

2. A high-pressure discharge lamp as claimed in claim 1, characterized in that a layer (3.1) with a higher refractive index and a layer (3.2) with a lower refractive index occur in alternation in the layer structure of the multilayer interference filter (3).

3. A high-pressure discharge lamp as claimed in claim 2, characterized in that the layer (3.2) of the interference filter (3) having the lower refractive index preferably comprises predominantly SiO₂, and the second layer (3.1) of the interference filter (3) is made of a material having a higher refractive index than SiO₂, preferably predominantly zirconium oxide (ZrO₂).

4. A high-pressure discharge lamp as claimed in claim 3, characterized in that the second layer (3.1) is made of a material chosen from the group of titanium oxide, tantalum oxide, niobium oxide, hafnium oxide, silicon nitride, particularly preferably zirconium oxide ZrO₂, or a mixture of these materials.

5. A high-pressure discharge lamp as claimed in claim 1, characterized in that the interference filter (3) is arranged in that location or at least in that location where the region of lowest temperature establishes itself at the outer contour of the burner wall (25).

6. A high-pressure discharge lamp as claimed in claim 1, characterized in that the interference filter (3) is arranged not in that location where the region of lowest temperature establishes itself at the outer contour of the burner wall (25).

7. A high-pressure discharge lamp as claimed in claim 1, characterized in that the high-pressure gas discharge lamp is a UHP lamp.

8. A high-pressure discharge lamp as claimed in claim 7, characterized in that the material of the burner wall (25) is made in particular of quartz, and accordingly the interference filter (3) is capable of reflecting mainly IR light in the wavelength range from 2 μm to 5 μm.

9. A lighting unit comprising at least a lamp as claimed in any claim 1.

10. A projection system comprising at least a lamp as claimed in claim 1.
